(19) United States
(12) Patent Application Publication
(10) Pub. No.: US 2022/0225637 A1
(43) Pub. Date: Jul. 21, 2022

(54) COMPOSITION COMPRISING EGGS AND USE OF SUCH COMPOSITION

(71) Applicant: IN OVO HOLDING B.V., Leiden (NL)

(72) Inventors: Wouter Sebastiaan BRUINS, Leiden (NL); Wil Marijn STUTTERHEIM, Leiden (NL); Pete ROWE, Nottingham Northamptonshire (GB)

(73) Assignee: IN OVO HOLDING B.V., Leiden (NL)

(21) Appl. No.: 17/613,282

(22) PCT Filed: May 22, 2020
(86) PCT No.: PCT/NL2020/050327

§ 371 Date: Nov. 22, 2021

(30) Foreign Application Priority Data
May 22, 2019 (NL) 2023176

(51) Int. Cl. A23K 10/20; A23K 50/90

(52) U.S. Cl. CPC A23K 10/20; A23K 50/90

(57) ABSTRACT

The present invention relates to a process for growing a feed organism from a composition comprising solid homogenized eggs, comprising collecting eggs that have been exposed to an incubation process; homogenizing the eggs; and subjecting the homogenized eggs to a denaturation process to obtain the solid homogenized eggs; and feeding the solid homogenized eggs to the feed organism. The present invention relates furthermore to the composition, and to its uses.

### FIELD OF THE INVENTION

The present invention relates to a process for preparing a composition comprising solid homogenized eggs, the solid homogenized eggs being exposed to an incubation process before. The present process further relates to the composition itself, and to its use of the composition as animal feed protein sources, in particular to feed organisms.

### BACKGROUND OF THE INVENTION

Fertilized eggs of most oviparous species tend to deliver an about equal distribution of male and female animals. However, for various reasons, in hatchery management, it is desirable to separate animals based upon gender. In commercial domestic chicken and egg production, incubation and rearing of male chicks is highly undesirable, leading to the culling of billions of male chicks every year. Currently, mixed populations of hatched animals are subjected to sexing by visual assessment of the juvenile animal, of sometimes even the adult population where juveniles do not have suitable traits. In either case, this is a highly time-consuming process, requiring highly skilled operators, and is typically very stressful for the animals. Also, where adult animals are sexed, the entire populations need to be reared to a minimum age, while only half of the thus reared animals are used for proliferation after separation. Further problems may occur where the presence of e.g. a male population may lead to reduced productivity due to e.g. cannibalism and reduced farming density.

There is also a percentage of eggs that are unfertilized, or do not comprise a viable embryo at the beginning of the incubation period, which greatly reduces the capacity of the incubators employed at hatcheries, in particular for poultry eggs. As a result, an incubation capacity is required which is at least twice as large as necessary if an early sex selection would be available, permitting the selection of primarily only male or female embryos. With an early stage method that determines the sex of avian embryos prior to the incubation phase, many of the above problems are solved. Methods are described in for example WO2006124456 where the determination of the presence of an estrogenic steroid compound as marker is used for the determination of sex, or in WO2017204636 where the determination is based on analyzing of samples from eggs in a mass spectrometer to obtain a biomarker pattern which are typical for male or female eggs.

When applying the above methods, a valuable protein source comes available in the form of eggs that have been exposed to a brooding machine for a period of time, but is then removed from the incubation process because of the sex selection.

A disadvantage of most methods mentioned herein above is that eggs are being produced that have been incubated for a period, and an embryo in a certain development phase is present in the egg. Hence there remains a need for a use of the incubated eggs.

Hatchery waste products, such as egg shells, damaged eggs, and incubated, but not hatched eggs are known to be processed into feed products, which usually is fed back to chicks, as for instance disclosed in Canadian patent application No. 1,081,035. However, this has de disadvantage that pathogens present in the hatchery waste may be recycled to the same species, resulting in potential amplification of the pathogens in the species, and resulting in issues with the life stock. Also, this waste has a comparatively low nutritional value. In U.S. Pat. No. 4,217,367 A is described a method of growing parasitic insect larvae on a growth medium containing vegetable protein isolate and a slowly ionizable acid or acid producing salt sufficient to maintain a pH below 8.5. A disadvantage of the described method is that a vegetable protein is being used, that requires a relatively large surface and water to be grown, and hence is not efficient.

### SUMMARY OF THE INVENTION

It is an object of the present invention to provide a composition comprising denaturized eggs that have been exposed to an incubation process. It is a further object of the invention to use the composition with denaturized incubated eggs for growing insect larvae. It is also an object of the present invention to provide a composition for growing fungi. It is in particular an object of the present invention to provide a process to grow a feed organism, preferably insects or fungi, on the composition comprising denaturized incubated eggs.

These and other objects are addressed by the composition and use of the present invention.

Accordingly, the present invention relates to a process for the preparation of a composition comprising solid homogenized eggs, the solid homogenized eggs obtained by:
(a) collecting eggs that have been exposed to an incubation process;
(b) homogenizing the eggs; and
(c) exposing the homogenized eggs to a denaturation process to obtain the solid homogenized eggs, and optionally,
(d) using the the composition as a food source for feed organisms.

In a further aspect, the present invention relates to the use of the composition as animal feed protein sources. In yet a further aspect, the composition is used for growing insect larvae. In yet a further aspect of the invention, the composition is used for growing fungi.

The present invention also relates to a composition comprising solid homogenized eggs, the solid homogenized eggs obtained by:
(e) collecting live eggs with a specific characteristic that have been exposed to an at least partial incubation process;
(f) homogenizing the eggs; and
(g) exposing the homogenized eggs to a denaturation process to obtain the solid homogenized eggs.

### DETAILED DESCRIPTION OF THE INVENTION

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

The terms “avian” and “bird” as used herein, include males or females of any avian species, but are primarily intended to encompass poultry which are commercially raised for eggs or meat. Accordingly, the terms “bird” and “avian” are particularly intended to encompass chicken, turkeys, ducks, geese, quail, doves, ostrich, emu, and pheasants.

The term “incubation” herein refers to the process by which oviparous animals, such as birds hatch their eggs, and to the development of the embryo within the egg after leaving the adults' tract. It furthermore refers to the industrial equivalent: process from incubation of the eggs to hatching in incubators, setters and outcome boxes. Incubation is therefore not limited to the natural process in which the mother does the main work.

The term “incubation period” herein refers to the uninterrupted time during which a particular egg is subjected to conditions emulating the brooding until the hatching, i.e. emergence of the hatchlings, including any handling or transfers from e.g. an incubator to a hatchery unit, provided the development of an animal is not stalled.

The term “denaturation process” herein refers to the process in which proteins or nucleic acids lose the quaternary structure, tertiary structure, and secondary structure which is present in their native state, by application of some external stress or compound such as a strong acid or base, a concentrated inorganic salt, an organic solvent (e.g., alcohol or chloroform), radiation or heat. If proteins in a living cell are denatured, this results in disruption of cell activity. Denatured proteins can exhibit a wide range of characteristics, from conformational change and loss of solubility to aggregation due to the exposure of hydrophobic groups. Denatured proteins lose their 3D structure and therefore cannot function.

The term “sex” and “gender” as used herein, are used interchangeably, and means in relation to the avian species either of the two divisions, designated female and male, by which most organisms are classified on the basis of their reproductive organs and functions.

The term “homogenized” herein refers to vigorously mixing of various substances such that a more or less homogeneous mixture is obtained.

The present invention may be practiced with any type of bird, fish, mollusk, reptilian or crustacean egg, including, but not limited to, (domesticated) chicken, turkey, duck, goose, quail, and pheasant eggs, fish, such as carp, salmonid or tilapia eggs; shrimp or prawn eggs, and mollusk eggs. A particularly preferred egg is the egg of the avian species, more preferably Gallus gallus domesticus due to its economic importance.

Eggs may be used for various applications, such as e.g. for vaccine production, by preferably injecting a virus or virus-like material into each egg identified as containing a live embryo and male or female. Then, after suitable incubation of the thus injected eggs, a vaccine or vaccine basis material may be isolated from the incubated eggs.

Suitable methods and apparatus for the penetration of eggs and invasively sampling of egg material are disclosed for instance in US-A-20070137577, WO-A-0022921 or WO-A-9934667. The thus taken sample is then preferably subjected to a suitable protocol to permit the detection of the developmental markers, and an analysis of the relative and/or absolute amounts of developmental markers present.

While the invasive methods permit to take a sample directly, and to subject the sampled fluid to an analysis, preferably the analysis is performed non-invasively due to the efficiency of such analysis method, and to the fact that the eggshell and membranes therein remain imperforated. Any suitable method may be employed to perform such non-invasive analysis.

A noninvasive analysis method involves solid-phase microextraction (SPME), coupled with a suitable analytical apparatus. SPME refers to a solid phase extraction sampling technique that involves the use of a fiber coated with an extracting phase, that can be a liquid (polymer) or a solid (sorbent), which extracts different kinds of analytes (including both volatile and non-volatile) from different kinds of media, that can be in liquid or gas phase. The quantity of analyte extracted by the fiber is proportional to its concentration in the sample as long as equilibrium is reached or, in case of short time pre-equilibrium, with help of convection or agitation. This may preferably be coupled with an IMS, so that the volatiles can be directly measured. Eggs comprising male and female embryos exhibit differences in chemical composition at the molecular level. At the macroscopic level the embryos may show differences in size, shape and cell morphology.

In WO-A-2017204636 a process is described that permits to determine the gender of an avian embryo via a non-destructive invasive method.

The eggs of the present invention have been exposed to an incubation period. Preferably, the eggs have been removed from the incubation process after an incubation period of from 30 hrs up to 300 hrs, more preferably of from 100 hrs up to 275 hrs, even more preferably of from 130 up to 240 hrs after the beginning of the incubation of the egg. Preferably, the eggs have been analyzed prior to definitive removal from the incubation process via an invasive non-destructive method, more preferably via the method as described in WO-A-2017204636.

After screening it is preferred to further expose the female eggs to the brooding process and to remove the male eggs and non-fertilized eggs from the incubator. Thus, for the male eggs and/or non-fertilized eggs the incubation period ends. The eggs that have been exposed to the incubation period are no longer fresh eggs and thus no longer suitable for human consumption. Furthermore, as the major part of the selected eggs have a particuarl characteristics, e.g. are eggs that would result in male chicks, they will likely, not become a commercial domestic chicken for egg or meat production. Thus, it is highly desirable to find a new use for these selected eggs. The advantage of the early selection is that it permits to avoid the costs involved in incubating and hatching eggs that are either no viable and/or not the desired gender. Furthermore, the actual developmental stage of an egg can be determined. For species with shorter or longer incubation times than those of domesticated chicken, other periods may apply, as suitable.

Preferably, the composition of the invention comprises the eggs that are mainly of the male type, i.e. comprising predominantly male embryos, embryos that are no longer alive, and/or non-fertilized eggs. The selection process for such eggs may include any useful technology able to determine gender or otherwise status of the egg, such as candling, or the methods disclosed in WO2014021715 or WO2017204636.

The eggs according to the invention are being homogenized. This can be performed using any technique to obtain a homogenized egg mass. The selected eggs that are fertilized may comprise a small embryo chicken of around 0.3 to 4 grams, more preferably from 0.3 to 2.4 grams. Preferably, the machine used destroys the embryos and the eggshells to such an extent that they are no longer visible with the eye. More preferably, the eggs are homogenized using an industrial food processor. Even more preferably, the eggs are homogenized using an industrial food processor with whisk blades to obtain an aerated substance. It might be preferred to have the egg shells removed prior to the homogenizing step. The eggs shells might be less nutritious for the use of the composition according to the invention.

According the present invention, the homogenized eggs are exposed to a denaturation process to obtain a solid texture. Denaturation is a process in which proteins or nucleic acids lose the quaternary structure, tertiary structure, and secondary structure which is present in their native state, by application of some external stress or compound such as a strong acid or base, a concentrated inorganic salt, an organic solvent (e.g., alcohol or chloroform), radiation or heat. Preferably, the primary structure, such as the sequence of amino acids held together by covalent peptide bonds, is not disrupted by the denaturation process. The denaturation process according to this invention is preferably irreversible.

Proteins can undergo the denaturation process through various chemical agents such as formamide, guanidine, sodium salicylate, dimethyl sulfoxide (DMSO), propylene glycol, and urea. These chemical denaturing agents lower the melting temperature by competing for hydrogen bond donors and acceptors with pre-existing nitrogenous base pairs. Some agents are even able to induce denaturation at room temperature. For example, alkaline agents (e.g. NaOH) have been shown to denature DNA by changing pH and removing hydrogen-bond contributing protons.

Denaturation due to air is also an option. Small, electronegative molecules such as nitrogen and oxygen, which are the primary gases in air, significantly impact the ability of surrounding molecules to participate in hydrogen bonding. These molecules compete with surrounding hydrogen bond acceptors for hydrogen bond donors, therefore acting as “hydrogen bond breakers” and weakening interactions between surrounding molecules in the environment.

For the composition of the present invention, the homogenized eggs are preferably exposed to radiation or heat, more preferably to heat, to become denaturized. These ways of denaturization are preferred, as for the further use of the denaturized eggs it is advantageously not to have added any further chemicals. Furthermore, it can be applied more easily on an industrial scale.

To expose the eggs to a denaturization process, they are first homogenized. The homogenized eggs are then poured into a baking mold. This baking mold can be any shape that keeps the homogenized mass together. It can be for example a baking tray, in any size that is suitable for the amount of homogenized eggs that need to be processed. It can also be a baking mold suitable for a large scale, for example for industrial baking machines that perform a continuous baking process. It is certainly not limited to a batch process only.

It is preferred according to the process of the invention to expose the homogenized eggs to heat to denaturize the eggs and to obtain a solid substance. Preferably, the homogenized eggs are poured into a baking mold, which is then exposed to a temperature of at least 63° C. until solid homogenized eggs are obtained. More preferably, the baking mold is exposed to a temperature in the range of from 100 up to 220° C., even more preferably in the range of from 160 up to 200° C. The time exposed to heat, to obtain solid denaturized eggs depends on the temperature, amount of homogenized eggs that is being processed, shape of the baking mold, whether pressure is applied and quality of the oven equipment. It is preferred to expose the homogenized eggs to heat for at least 15 minutes.

It is furthermore preferred to expose the homogenized eggs to heat for at most 150 minutes.

Alternatively, the baking mold is exposed to a temperature in the range of from 100 to 150° C., a pressure of from 75 up to 200 kPA for at least 15 minutes. Alternatively, a continuous process may be applied, wherein e.g. the homogenized eggs are subjected to the above conditions in a suitable way, e.g. a heated transport belt, a belt that passes through an oven a microwave oven, or a heated tube, extruder or other type of Device able to transport and heat the composition. The exact shape or form of this alternative process is not important, as long as the product obtained has the desired properties. The composition may also be subjected to shaping, sizing and/or pelletizing.

Prior to homogenizing the eggs, it is possible to add one or more compounds or ingredients to the eggs to obtain a homogenized mixture before denaturizing. The addition of certain ingredients depends on the intended use of the composition. The composition according to the invention preferably has further compounds added to the eggs prior to the homogenizing step. More preferably, these compounds may comprise one or more of the feed ingredients chosen from the list comprising, but not limited to, optionally dehydrated alfalfa, barley, beet pulp, blood meal, brewers grain, buttermilk, citrus pulp, coconut meal, corn, corn cob and meal, corn gluten feed, corn gluten meal, corn oil meal, cottonseed meal, distillers grain, distillers solubles, fish meal, hominy, kafir corn, kafir head chop, linseed meal, meat scrap, milo maize, milo head chop, molasses, oats, oat hulls, oat screening, peanut meal, rice bran, rice polishings, soybean meal, wheat, wheat-mids, wheat flour, wheat bran, whey, bone meal and urea, are uniformly mixed. In addition, minerals and mineral supplements may also be incorporated. Also, water or other fluids may be added to a desired humidity level. Water may be added up to 50 wt %, more preferably up to 40 wt %, even more preferably up to 30 wt % relative to the total weight of the homogenized mixture.

The above compounds can also be added after the eggs have been homogenized, but preferably before the denaturizing step. Compounds and amount remain the same.

It is also possible to add compounds to the composition after the denaturization step has taken place. This depends on the intended use of the composition. Thus, in an alternative embodiment of the invention, it is preferred to have a composition that furthermore comprises water, next to the denaturized homogenized eggs. The ratio of water relative to the eggs depends preferably on the intended use, e.g. the feed organism, such as an insect or fungus that is being fed. Preferably, the feed organism is selected from a species that is useful as feed for chicks or animals in general, but from an entirely different class, preferably a different phylum. This will ensure that pathogens in one species are not present, and will not stay present in the feed organism, thereby reducing the impact on eventually suing the thus grown biomass as feed material for the originating oviparian species. Examples include prions, viruses, and bacteria. Particularly useful feed organisms include insects, and fungi.

For example, the diet of a black soldier fly preferably comprises less water than for other insects. Preferably, the composition comprises more than 15 wt % of water, and it comprises preferably less than 70 wt % of water, more preferably more than 20 wt % of water and less than 55 wt % of water. Water is for the growth of insects a valuable addition, as the growth of insects is improved. Next to water the composition can comprise other ingredients or compounds. More preferably, these compounds may comprise one or more of the group of soybean meal, various feed ingredients chosen from the list comprising, but not limited to, optionally dehydrated alfalfa, barley, beet pulp, unmolassed sugar beet pulp pellets, blood meal, brewers grain, buttermilk, citrus pulp, coconut meal, corn, corn cob and meal, corn gluten feed, corn gluten meal, corn oil meal, cottonseed meal, distillers grain, distillers solubles, fish meal, hominy, kafir corn, kafir head chop, linseed meal, meat scrap, milo maize, milo head chop, molasses, oats, oat hulls, oat screening, peanut meal, rice bran, rice polishings, soybean meal, wheat, wheat-mids, wheat flour, wheat bran, whey, bone meal and urea, are uniformly mixed. In addition, minerals and mineral supplements may also be incorporated. Thus, a composition according to the invention advantageously comprises of from 10 to 50 wt % of one of more of the compounds, of from 15 to 70 wt % of water and of from 10 up to 75 wt % of denaturized egg.

The present invention is furthermore directed to the use of the before described composition as animal feed protein source. The composition is preferably used to grow insects, more preferably edible insects.

The term “edible insect” as used herein preferably means an insect which can be safely used as a food source for humans and/or birds and/or reptiles and/or fish and/or pigs and/or ruminants, particularly humans and/or birds. Examples of edible insects are set forth in the report: “Edible insects: future prospects for food and feed security”, FAO Forestry Paper 171, Food and Agriculture Organization of the United Nations (Rome, 2013); and in the articles: “Insects—a natural nutrient source for poultry—a review”, Ann. Anim. Sci., Vol. 16, No. 2 (2016) 297-313; “Black soldier fly as dietary protein source for broiler quails . . . ”, Animal, pages 1-8, © The Animal Consortium 2016; and “Extraction and characterization of protein fractions from five insect species”, Food Chemistry 141 (2013) 3341-3348.

Among “edible insects” are grasshoppers, soldier flies, crickets, cockroaches, termites, lice, stink bugs, cicadas, aphids, scale insects, psyllids, beetles, caterpillars, flies, fleas, bees, wasps and ants, as well as desert locusts, housefly maggots and silkworms. While all stages of edible insects can be used, the larval stage is preferred. Insects generally have two types of life cycle; complete and incomplete metamorphosis. Complete metamorphosis is the type of insect development that includes egg, larva, pupal, and adult stages, which differ greatly in morphology.

Of the insects approved for food use, black soldier fly, housefly, yellow mealworm and lesser mealworm undergo complete metamorphosis. The house cricket, banded cricket and field cricket undergo life cycles which involves incomplete metamorphosis. Incomplete metamorphosis is a type of insect development in which an egg hatches into a young nymph and progresses through into a later nymph and then into an adult insect. There is no larval stage during incomplete metamorphosis; a nymph is basically like an adult insect in every way except in size; behavior and eating habits are the same as opposed to insects with complete metamorphosis that have 4 distinctly different visual and behavioral stages of development.

Preferred edible insects, particularly for birds are live edible insects. Preferred species of edible insects include the lesser meal worm (Alphitobius diaperinus), the buffalo worm (Alphitobius laevigatus) and the meal worm beetle (Tenebrio molitor), particularly their larvae, more particularly the larvae of the lesser meal worm. In this regard, the average dimensions of the larvae of the lesser meal worm, with a maximal reported length of 20 mm, appears to provide an ideal length and proportion for newly hatched birds, particularly newly hatched chicks.

The term “larva” or “larvae” as used herein preferably means the active immature form of an edible insect which can be consumed and digested by birds or reptiles. A preferred edible insect larva is a lesser meal worm larva.

Preferably, the edible insects and their parts do not serve as a vector for pathogens that could negatively a bird or reptile. Where a species is known to act as a vector, the edible insect is preferably bred to be free from harmful pathogens for the bird or reptile. Preferably, the edible insects are chosen from the families of flies, mealworms, crickets More preferably, the insects are chosen from the group authorized insects for production of insects according to the EU commission regulation 2017/893 (EU 2017). Even more preferably, the insects are the Black Soldier Fly (Hermetia illucens) or the Common housefly (Musca domestica) or the Yellow Mealworm (Tenebrio molitor) or the lesser Mealworm (Alphitobius diaperinus) or the buffalo worm (Alphitobius laevigatus) or a mixture thereof.

Seven (7) insects are currently approved to be fed to food producing animals if the insect is alive and also used to get PAP to feed to aquaculture and pets. Many more insects are allowed be fed to pets in the live form. These seven insects for feed production pursuant to EU commission regulation 2017/893 (EU 2017) are: Black Soldier Fly (Hermetia illucens); Common housefly (Musca domestica); Yellow Mealworm (Tenebrio molitor); Lesser Mealworm (Alphitobius diaperinus); House cricket (Ancheta domesticus); Banded cricket (Gryllodes sigillatus); and Field cricket (Gryllus assimilis).

The invention is also directed to the intermediate product, the product obtainable by steps a and b; being the composition comprising homogenized eggs, the homogenized eggs obtained by collecting eggs that have been exposed to an incubation process and homogenizing the eggs. This egg composition has not yet been exposed to the denaturation process and can for example be stored as in intermediate product or might suitably be used to add for example fungi to.

The present invention is furthermore directed to the use of the before described composition as protein source for growing fungi. A fungus is any member of the group of eukaryotic organisms that includes microorganisms such as yeasts and molds, as well as the more familiar mushrooms. Fungi include symbionts of plants, animals, or other fungi and also parasites. They may become noticeable when fruiting, either as mushrooms or as molds. Fungi perform an essential role in the decomposition of organic matter and have fundamental roles in nutrient cycling and exchange in the environment. They have long been used as a direct source of human food, in the form of mushrooms and truffles; as a leavening agent for bread; and in the fermentation of various food products, such as wine, beer, and soy sauce. Fungi are highly efficient organisms in terms of protein conversion, and a such many fungi are useful as fee organism.

Yet further, since the 1940's, fungi have been used for the production of antibiotics, and, more recently, various enzymes produced by fungi are used industrially and in detergents. Fungi are also used as biological pesticides to control weeds, plant diseases and insect pests. Many species produce bioactive compounds called mycotoxins, such as alkaloids and polyketides, that are toxic to animals including humans.

A special kind of fungus is the entomopathogenic fungus. The entomopathogenic fungus is a fungus that can act as a parasite of insects and kills or seriously disables them.

These fungi usually attach to the external body surface of insects in the form of microscopic spores (usually asexual, mitosporic spores also called conidia). Under the right conditions of temperature and (usually high) humidity, these spores germinate, grow as hyphae and colonize the insect's cuticle; which they bore through by way of enzymatic hydrolysis, reaching the insects' body cavity (hemocoel). Then, the fungal cells proliferate in the host body cavity, usually as walled hyphae or in the form of wall-less protoplasts (depending on the fungus involved). After some time, the insect is usually killed (sometimes by fungal toxins), and new propagules (spores) are formed in or on the insect if environmental conditions are again right. High humidity is usually required for sporulation. Since they are considered natural mortality agents and environmentally safe, there is worldwide interest in the use and manipulation of entomopathogenic fungi for biological control of insects and other arthropod pests. In particular, the asexual phases of Ascomycota (Beauveria spp., Isaria spp., Lecanicillium spp., Metarhizium spp., Purpureocillium spp. and others) are under intense scrutiny due to traits favoring their use as biological insecticides. For the present invention it is preferred to use the before described composition as protein source for growing fungi as food source, and/or entemopathogenic fungi, for use in insect control. A combination of both then would deliver a food source which also contains spores that may affect the presence of pathogenic insects in the chick rearing, e.g. red mites.

The following, non-limiting examples are provided to illustrate the invention.

### EXAMPLE 1

Black soldier flies were used to test the egg composition on the growth of larvae. Generally, the diet consists of wheat bran and corn meal. An amount of 187.5 gram of wheat bran was added to 112.5 gram of cornmeal. A total of 510 ml water was added to moisten. Separately 300 ml of eggs that had been exposed to an incubation period of 9 days were homogenized using a blender. The homogenate was then autoclaved at a temperature of 121° C., pressure of 100 kPa for 20 minutes. Five different food compositions were made with 0, 25, 50, 75 and 100% egg, based on weight, in addition to the wheat bran, cornmeal and water mixture. The moisture content of the food was between 60-70% for all the diets as the autoclaved egg contains about 70% moisture and the wheat bran and cornmeal part of the diet was moistened to 62.5%. The results are in table 1. The starting size of larvae was 125 larvae, with a total sample size of 60.0 gram. The total amount of food given to the larvae was in all cases 40.0 gram, with a feed water composition of 70%.

TABLE 1
Growth results obtained for feeding black soldier flies with
different compounds comprising varying amounts of eggs.

| | | | | | |
|---|---|---|---|---|---|
| % Egg in sample (by | 0 | 25 | 50 | 75 | 100 |
| weight) | | | | | |
| 5 day survival (%) | 100 | 99.2 | 99.2 | 100 | 100 |
| Weight gain: | | | | | |
| Sample weight day 0 (g) | 2.54 | 2.37 | 2.51 | 2.53 | 2.64 |
| Sample weight day 5 (g) | 4.47 | 5.04 | 6.11 | 6.43 | 5.29 |
| Total weight gain (g) | 1.93 | 2.67 | 3.60 | 3.90 | 2.65 |
| Weight gain (%) | 76 | 113 | 143 | 154 | 100 |
| Weight gain normalized | 76 | 112 | 142 | 154 | 100 |
| to survival % (%) | | | | | |
| Feed efficiency (% dry | 17 | 23 | 31 | 34 | 23 |
| food to converted mass) | | | | | |

### EXAMPLE 2

Yellow mealworm and lesser mealworm were used to test the egg composition on the growth of larvae. Generally, the diet consisted of wheat bran, macerated unmolassed sugar beet pulp pellets, wheat flour, corn flour and soymeal. A mixture containing, based on % weight of each ingredient, 50% wheat bran, 10% macerated unmolassed sugar beet pulp pellets, 7.75% wheat flour, 7.75% corn flour, and 24.5% soymeal, was prepared for the experiments. Separately, 300 ml of eggs that had been exposed to an incubation period of 9 days were homogenized and aerated for 20 minutes in a food processor until a thick custard like texture was formed. It was then poured into a baking tray lined with oil and heated at 180° C. for 40 minutes. The heated egg cakes were removed from the tray and then dried at 100° C. for 3 hours. The dried egg cake was then macerated in a blender to make an egg powder. The egg powder was then added to the mixture in 0, 25, 50 and 75% egg powder in terms of weight. The starting size of larvae was 125 larvae of the yellow mealworm (20.0 gram) and lesser mealworm (125 gram). The total amount of food given to the larvae was in all cases 40.0 gram. The yellow mealworm and lesser mealworm were fed 10g of feed and 2 g of carrot 2 times over 5 days before being weighed and counted on the 5th. The incubator was kept at 28° C. and a relative humidity of 70%. The results are in tables 2 and 3. The total amount of food given to the larvae was in all cases 28 gram, with a feed water composition of 25%.

TABLE 2
Growth results obtained for yellow mealworm with different
compounds comprising varying amounts of eggs.

| | | | | |
|---|---|---|---|---|
| % Egg in sample | 0 | 25 | 50 | 75 |
| 5 day survival (%) | 84 | 91 | 94 | 78 |
| Weight gain: | | | | |
| Sample weight day 0 (g) | 4.31 | 4.85 | 4.90 | 5.61 |
| Sample weight day 5 (g) | 7.49 | 7.76 | 7.98 | 7.30 |
| Total weight gain (g) | 3.18 | 2.91 | 3.08 | 1.69 |
| Weight gain (%) | 74 | 60 | 63 | 30 |
| Weight gain normalized | 62 | 55 | 59 | 23 |
| to survival % (%) | | | | |
| Feed efficiency (% dry | 13 | 13 | 14 | 6 |
| food to converted mass) | | | | |

TABLE 3
Growth results obtained for lesser mealworm with different
compounds comprising varying amounts of eggs.

| | | | | |
|---|---|---|---|---|
| % Egg in sample | 0 | 25 | 50 | 75 |
| 5 day survival (%) | 93 | 85 | 79 | 70 |
| Weight gain: | | | | |
| Sample weight day 0 (g) | 1.42 | 1.37 | 1.38 | 1.20 |
| Sample weight day 5 (g) | 1.68 | 1.68 | 1.62 | 1.57 |
| Total weight gain (g) | 0.26 | 0.31 | 0.24 | 0.37 |
| Weight gain (%) | 18 | 23 | 17 | 31 |
| Weight gain normalized | 17 | 19 | 14 | 22 |
| to survival % (%) | | | | |
| Feed efficiency (% dry | 1 | 1 | 1 | 1 |
| food to converted mass) | | | | |

When looking at the results of the above 2 experiments, it may be concluded that the black soldier fly had a near 100% survival percentage for all feed compositions tested. For the yellow mealworm and lesser mealworm, the survival percentage dropped below 80% when the feed composition comprises 75% egg. Furthermore, the black soldier fly larvae converted more of the feed ingested into body mass than the other two insects tested. In terms of production, the black soldier fly showed a higher rate of feed consumption and therefore was found to ingest the egg at a higher rate, and also to develop quicker.

1. A process for growing a feed organism from a composition comprising solid homogenized eggs, comprising
(a) collecting eggs that have been exposed to an incubation process;
(b) homogenizing the eggs;
(c) subjecting the homogenized eggs to a denaturation process to obtain the solid homogenized eggs; and
(d) feeding the solid homogenized eggs to the feed organism.

2. The process according to claim 1, wherein in (c) the homogenized eggs are exposed to a temperature of at least 63° C. until solid homogenized eggs are obtained, preferably wherein the homogenized eggs are poured into a baking mold prior to exposure.

3. The process according to claim 1, wherein the eggs have been exposed to an incubation period for of from 30 hours up to 300 hours, more preferably of from 100 hours up to 275 hours, even more preferably of from 130 up to 240 hours, prior to step (a).

4. The process according to claim 1, wherein the eggs are of an avian species, more preferably of Gallus gallus domesticus.

5. The process according to claim 1, wherein the eggs are mainly of the male type, eggs comprising deceased embryos and/or non-fertilized eggs.

6. The process according to claim 1, wherein the egg shells are removed prior to the homogenizing step (b).

7. The process according to claim 1, wherein further materials are added to the eggs prior to the homogenizing step.

8. The process according to claim 7, wherein the materials are one or more of optionally dehydrated alfalfa, barley, beet pulp, blood meal, brewers grain, buttermilk, citrus pulp,coconut meal, corn, corn cob and meal, corn gluten feed, corn gluten meal, corn oil meal, cottonseed meal, distillers grain, distillers solubles, fish meal, hominy, kafir corn, kafir head chop, linseed meal, meat scrap, milo maize, milo head chop, molasses, oats, oat hulls, oat screening, peanut meal, rice bran, rice polishings, soybean meal, wheat, wheat-mids, wheat flour, wheat bran, whey, bone meal and urea, or combinations thereof

9. The process according to claim 1, wherein the exposure is to a temperature in the range of from 100 up to 220° C., more preferably in the range of from 160° C. up to 200° C.

10. The process according to claim 1, wherein the baking mold is exposed to a temperature in the range of from 100 to 150° C., a pressure of from 75 up to 200 kPA for at least 15 minutes.

11. The process according to claim 1, wherein the eggs are homogenized using an industrial food processor.

12. The process according to claim 1, wherein the eggs are homogenized using an industrial food processor with whisk blades, to obtain an aerated substance to be exposed to the denaturing conditions, preferably by pouring into a baking mold.

13. The process according to claim 1, wherein the homogenized eggs or the solid homogenized eggs furthermore comprise water in a range of from 1 to 25% by weight, preferably 1 to 10 weight %, as determined prior to baking, or as end-humidity, respectively.

14. A composition obtained according steps (a) to (b), preferably (a) to (c) of claim 1.

15. Use of a composition according to claim 14, wherein the composition is used to grow a feed organism, preferably insects or fungi.

16. Use according to claim 15, wherein the insects are chosen from the families of flies, mealworms, and/or crickets.

17. Use according to claim 15, wherein the insects are chosen from the group of insects authorized for food production according to the EU commission regulation 2017/893 (EU 2017).

18. Use according to claim 16, wherein the insects are the Black Soldier Fly (Hermetia illucens), the Common housefly (Musca domestica), the Yellow Mealworm (Tenebrio molitor), the lesser Mealworm (Alphitobius diaperinus) or buffalo worm (Alphitobius laevigatus), or a mixture thereof.

19. (canceled)

20. (canceled)

21. Use according to claim 15, wherein the fungus comprises an Entemopathogenic Fungus, to obtain an insecticidal material.
